(19) United States
(12) Patent Application Publication
(10) Pub. No.: US 2004/0038014 A1
(43) Pub. Date: Feb. 26, 2004

(54) Fiber containing filter media

(75) Inventors: James W. Schaefer, Lakeville, MN (US); Marty A. Barris, Lakeville, MN (US); Thomas M. Weik, Deephaven, MN (US)

Correspondence Address: MERCHANT & GOULD PC, P.O. BOX 2903, MINNEAPOLIS, MN, 55402-0903, US

(73) Assignee: Donaldson Company, Inc.

(21) Appl. No.: 10/411,567

(22) Filed: Apr. 7, 2003

Related U.S. Application Data
(63) Continuation-in-part of application No. 10/225,561, filed on Aug. 20, 2002.

(51) Int. Cl. B32B 27/04; B32B 1/00; B32B 27/12

(52) U.S. Cl. 428/220; 442/340; 442/345; 442/381; 442/389; 156/166; 156/180; 156/181

(57) ABSTRACT

Improved filtration media or filter bodies can be made from fine fiber and can be formed into a filtration structure having no internal defects. The filter media or filter body comprises a collection of spot in fiber with defined fiber diameter, layer thickness and media solidity. The fine fiber is formed into a media body and obtains substantial flux and filtration efficiency. The filtration media or body can comprise single or multiple layers of fine fiber combined into the improved filter body.

### RELATED APPLICATION

This application is a continuation-in-part application of U.S. Ser. No. 10/225,561 filed Aug. 20, 2002 that is incorporated by reference herein.

### FIELD OF THE INVENTION

The invention relates to media, filter arrangements and methods. More specifically, it concerns arrangements for filtering particulate material from fluid streams such as gas or liquid streams, for example, air or aqueous streams. The invention also concerns methods for achieving the desirable removal of particulate material from such fluid streams. The invention relates to an improved filter medium or a structure using an improved fine fiber medium. More importantly, the invention relates to fibrous filter materials that can be manufactured in a “defect free” structure and can maintain effective filtration capacity for a substantial period of time.

### BACKGROUND OF THE INVENTION

Fluid, i.e., liquid and gaseous streams often carry entrained particulate material. In many instances, the substantial removal of some or all of the particulate material from a fluid stream can be important for reasons including safety and health, machine operation and aesthetics. For example, air intake streams to engines for motorized vehicles or power generation equipment, streams directed to gas turbines, and air streams to various combustion furnaces, often include entrained particulate. The particulate material, should it reach the internal workings of the various mechanisms involved, can cause substantial damage. In other instances, production gases or off gases from industrial processes may contain particulate material therein, for example, those generated by the process. Before such gases can be, or should be, directed through various downstream equipment and/or to the atmosphere, the substantial removal of particulate material from those streams can be required. A variety of air filter or gas filter arrangements have been developed for particulate removal using an array of media materials in a variety of forms.

Typically, filter media materials are used in filtration structures placed in the fluid path. The media typically obtain the physical separation of the particulate from the fluid flow. Media are typically relatively mechanically stable, have reasonable permeability, relatively small pore size, low pressure drop and resistance to the effect of the fluid such that it can effectively remove the particulate from the fluid over a period of time without serious mechanical media failure. Media can be made from a number of materials in a woven or non-woven form. Such materials can be air laid, water laid, melt blown, or otherwise formed into a sheet-like material with an effective pore size, porosity, solidity or other filtration requirements.

Non-woven filter elements can be used as surface loading media. In general, such elements comprise dense mats of cellulose, glass, PTFE, synthetic or other fibers oriented across a stream carrying particulate material. The media is generally constructed to be permeable to the gas flow, and to also have a sufficiently fine pore size and appropriate porosity to inhibit the passage of particles greater than a selected size therethrough. As materials pass through the filter paper, the upstream side of the filter paper operates through diffusion and interception to capture and retain selected sized particles from the gas (fluid) stream. The particles are collected as a dust cake on the upstream side of the filter paper. In time, the dust cake also begins to operate as a filter, increasing efficiency. This is sometimes referred to as “seasoning,” i.e. development of an efficiency greater than initial efficiency.

Types of media usable in air cleaner systems, including some using principles disclosed herein include: open cell foam, for example polyurethane foam media available from foam suppliers such as BASF Corporation, Wyandotte, Mich.; or, 3M, St. Paul, Minn.; and, in some instances, microporous media. For example, stretched polytetrafluoroethylene (PTFE) membranes comprising nodes interconnected by fibrils, of the type generally manufactured by or under the direction of W. L. Gore and Associates, Inc., of Newark, Del. and marketed under the designation Gore-Tex®; and, the PTFE material manufactured by Tetratec, a division of Donaldson Company Inc., and marketed under the trade designation Tetratex®, are microporous membranes. Techniques for manufacture of such microporous membranes are generally provided in U.S. Pat. Nos. 3,953,566; 4,187,390; 4,110,239; and 5,066,683, incorporated herein by reference. In many instances, such membranes are utilized in air cleaner filter constructions wherein the membrane is laminated to a substrate, for example, a scrim; or, wherein the membrane is positioned between various substrates, such as two layers of felt or scrim. In general, PTFE membranes, or similar microporous membranes, operate as surface loading or barrier filters. (Open cell foam membranes, on the other hand, typically operate as depth media.)

Yet another media used in filtration equipment involves the use of glass fiber. Such glass fiber media are typically relatively small diameter glass fiber arranged in either a woven or non-woven structure having substantial resistance to chemical attack and able to have relatively small porosity and high efficiency (HEPA) in filter cartridge applications. Such glass fiber media are shown in the following U.S. Patent numbers: Smith et al., U.S. Pat. No. 2,797,163; Waggoner, U.S. Pat. No. 3,228,825; Raczek, U.S. Pat. No. 3,240,663; Young et al., U.S. Pat. No. 3,249,491; Bodendorfet al., U.S. Pat. No. 3,253,978; Adams, U.S. Pat. No. 3,375,155; and Pews et al., U.S. Pat. No. 3,882,135. Yet another filtration media, which utilizes spaced fine fiber structures, is characterized in Donaldson U.S. Pat. No. 5,672,399 incorporated herein by reference, and commonly assigned U.S. application Ser. No. 08/935,103 filed Sep. 29, 1997, incorporated herein by reference. Such a material could be viewed as a hybrid between a depth media type structure and a surface-loading structure. That is, the particles will be distributed through the depth of such an arrangement, but the fine fiber layers will each generally operate, in part, as a form of barrier, with, in some instances, the spacing material operating primarily to separate the fine fiber layers and to allow for load. Such media can also be used in selected arrangements including principles as characterized herein.

### BRIEF DISCUSSION OF THE INVENTION

We have found an effective filter media can be made by forming filter media from a polymeric material and forming the fiber into a relatively thick collection of fine fiber. The fine fiber in a layer preferably has a diameter of about 0.0 to about 1 micron, preferably about 0.03 to 0.5 micron. The layer containing the fiber has a thickness of about 1 to 100 microns and has a media solidity of about 5% to 50% preferably about 5% to 30%. The polymeric filter media of the invention are made from organic polymer materials other than perfluorinated polymers. These media can be used to filter fluids, including gaseous and liquid fluids. The preferred media of the invention has a thickness of about 5 to 100 microns and a substantial flux that can be maintained over a substantial filter lifetime that is greater than about 10 mL-min⁻¹-cm² at 10 psi of water. In one aspect of the media of the invention, the media solidity can be about 7% to 25% when used to filter fluid a flux of greater than 10 mL-min⁻¹-cm² at 10 psi and a test filtration efficiency of at least about 98% on a particle about 0.2 microns, when tested at a flow rate of approximately 20 mL/min/cm² of water.

The media of the invention is typically made by forming a fine fiber into a relatively thick media layer in a single pass or by building up the thickness of the media using multiple passes through an electrostatic spinning process. The formed filter mat can then be exposed to conditions of temperature and pressure that can compress the layer into a mechanically stable media layer that has a substantial defect-free characteristic that can effectively remove particulate from the fluid stream. In this invention, the term “defect-free” means that when a filter element or cartridge is made using the media of the invention, that the media can remove substantial quantities of particulate from a fluid stream without failure arising from the particulate passing through a defect path having a pore size substantially greater than the pore formed in the manufacturing process. In the invention, the media has a filtration efficiency of about 98% on a particle about 0.2 micron at a flow rate of about 20 mL-min⁻¹-cm² of water. Any deep path that would reduce the efficiency of the media below this parameter will constitute a defect path.

The invention also relates to polymer materials can be manufactured with improved environmental stability to heat, humidity, reactive materials and mechanical stress. Such materials can be used in the formation of fine fibers such as microfibers and nanofiber materials used in the media of the invention with improved stability and strength. As the size of fiber is reduced the survivability of the materials is increasingly more of a problem. Such fine fibers are useful in a variety of applications. In one application, filter structures can be prepared using this fine fiber technology. The invention relates to polymers, polymeric composition, fiber, filters, filter constructions, and methods of filtering. Applications of the invention particularly concern filtering of particles from fluid streams, for example from air streams and liquid (e.g. non-aqueous and aqueous) streams. The techniques described concern structures having one or more layers of fine fibers in the filter media. The compositions and fiber sizes are selected for a combination of properties and survivability.

The filter media includes at least a micro- or nanofiber media layer optionally in combination with a substrate material or a porous support in a mechanically stable filter structure. These layers together provide excellent filtering, high particle capture, efficiency at minimum flow restriction when a fluid such as a gas or liquid passes through the fine fiber filter media of the invention. The media of the invention can be positioned in the fluid stream upstream, downstream or in an internal layer. A variety of industries have directed substantial attention in recent years to the use of filtration media for filtration, i.e. the removal of unwanted particles from a fluid such as gas or liquid. The common filtration process removes particulate from fluids including an air stream or other gaseous stream or from a liquid stream such as a hydraulic fluid, lubricant oil, fuel, water stream or other fluids. Such filtration processes require the mechanical strength, chemical and physical stability of the microfiber and the substrate materials. The filter media can be exposed to a broad range of temperature conditions, humidity, mechanical vibration and shock and both reactive and non-reactive, abrasive or non-abrasive particulates entrained in the fluid flow. Further, the filtration media often require the self-cleaning ability of exposing the filter media to a reverse pressure pulse (a short reversal of fluid flow to remove surface coating of particulate) or other cleaning mechanism that can remove entrained particulate from the surface of the filter media. Such reverse cleaning can result in substantially improved (i.e.) reduced pressure drop after the pulse cleaning. Particle capture efficiency typically is not improved after pulse cleaning, however pulse cleaning will reduce pressure drop, saving energy for filtration operation. Such filters can be removed for service and cleaned in aqueous or non-aqueous cleaning compositions. Such media are often manufactured by spinning fine fiber and then forming an interlocking web of microfiber on a porous substrate. In the spinning process the fiber can form physical bonds between fibers to interlock the fiber mat into a integrated layer. Such a material can then be fabricated into the desired filter format such as cartridges, flat disks, canisters, panels, bags and pouches. Within such structures, the media can be substantially pleated, rolled or otherwise positioned on support structures.

Polymer nanofibers and microfibers are known, however, their use has been very limited due to their fragility to mechanical stresses, and their susceptibility to chemical degradation due to their very high surface area to volume ratio. The fibers described in this invention address these limitations and will therefore be usable in a very wide variety of filtration, textile, membrane and other diverse applications. The filter should maintain the ability to filter, load particulate during filtration into the fibrous matrix while maintaining a practical flow rate or filtration speed and an acceptable pressure drop.

The “lifetime” of a filter is typically defined according to a selected limiting pressure drop across the filter. The pressure buildup across the filter defines the lifetime at a defined level for that application or design. Since this buildup of pressure is a result of load, for systems of equal efficiency a longer life is typically directly associated with higher capacity. Efficiency is the propensity of the media to trap, rather than pass, particulates. It should be apparent that typically the more efficient a filter media is at removing particulates from a gas flow stream, in general the more rapidly the filter media will approach the “lifetime” pressure differential (assuming other variables to be held constant).

Herein the term “filter element” is generally meant to refer to a portion of the air cleaner which includes the filter media therein. The filter element provides the mechanical separation of the particulate from the fluid. In general, a filter element will be designed as a removable and replaceable, i.e. serviceable, portion of the air cleaner. That is, the filter media will be carried by the filter element and be separable from the remainder portion of the air cleaner so that periodically the air cleaner can be rejuvenated by removing a loaded or partially loaded filter element and replacing it with a new, or cleaned, filter element. Preferably, the air cleaner is designed so that the removal and replacement can be conducted by hand. The term “filter media” or “media” refers to a material or collection of material through which the fluid passes, with a concomitant and at least temporary deposition of the particles in or on the media.

The conventional media discussed above have had adequate performance in assigned roles in filtration equipment and processes. However, these media all suffer from various problems including increased back pressure or pressure drop during use, relatively large pore size, permeability problems and other problems relating to the rate of flow of material through the filter over the filtration lifetime. A substantial need exists in the art to improve filter media by reducing effective pore size, increasing the range of particulate that can be filtered from air and gas streams, while maintaining high permeability, long service life and controllable pressure drop.

The filter media of the invention can be used in virtually any application involving the filtration of the fluid including gaseous streams and liquid streams. The material can be used for the removal of a variety of particulate matter from the streams. The particulate matter can include both organic and inorganic contaminants. Organic contaminants can include large particulate natural products, organic compounds, polymer particulate, food residue and other materials. Inorganic residue can include dust, metal particulate, ash, smoke, mist and other materials.

The filtration media of the invention can be used in virtually any conventional structure including flat panel filters, oval filters, cartridge filters, spiral wound filter structures and can be used in pleated, Z filter or other geometric configurations involving the formation of the media to useful shapes or profiles.

### DETAILED DISCUSSION OF THE INVENTION

The invention relates to a filter medium, filter element, filter cartridge, or other filter technology comprising a fine fiber filter medium. The fine fiber filter medium comprises a substantially organic polymeric fine fiber substantially free of a perfluorinated polymer material comprising a collection of fiber in a media layer, the fiber having a diameter of about 0.03 to 0.5 micron, a thickness of about 1 to 100 microns and a solidity of about 5% to 50% or about 5% to 30%. Increasing solidity permits a reduction in thickness without substantial reduction in efficiency or other filter properties. Increased solidity, at constant thickness, up to a limit of about 50%, reduces pore size and increases particulate storage. Such a filter media technology can be used in a variety of filtration methods for removing particulate from a fluid stream, in particular, a particulate from a liquid, preferably an aqueous stream.

The fine fibers that comprise the micro- or nanofiber containing layer of the invention can be fiber and can have a diameter of about 0.01 to 2 micron, preferably 0.03 to 0.5 micron. The thickness of the typical fine fiber filtration layer ranges from about 0.1 to 100 times the fiber diameter with a basis weight ranging from about 5 to 35 micrograms-cm⁻² and a solidity by volume of up to 50%.

The improved polymer material has improved physical and chemical stability. The polymer fine fiber can be fashioned into useful product formats. Nanofiber is a fiber with diameter less than 200 nanometer or 0.2 micron. Typical media have fiber diameters of greater than about 1T. This fine fiber can be made in the form of an improved single layer or multi-layer microfiltration media structure. The fine fiber layers of the invention comprise a random distribution of fine fibers which can be bonded to form an interlocking net. Filtration performance is obtained largely as a result of the fine fiber processing the fluid and establishing a barrier to the passage of particulate. Structural properties of stiffness, strength, pleatability are provided by the substrate to which the fine fiber adhered. The fine fiber interlocking networks have as important characteristics, fine fibers in the form of microfibers or nanofibers and relatively small spaces (pore size) between the fibers. Such spaces typically range, between fibers, of about 0.01 to about 25 microns or often about 0.1 to about 10 microns. The filter products comprising a fine fiber layer and an optional support or other media layer. In service, the filters can stop incident particulate from passing through the fine fiber media layer and can attain substantial surface loadings of trapped particles. The particles comprising dust or other incident particulates rapidly form a dust cake on the fine fiber surface and maintains high initial and overall efficiency of particulate removal. Even with relatively fine contaminants having a particle size of about 0.01 to about 1 micron, the filter media comprising the fine fiber has a very high dust capacity.

The fine fiber media of the invention can be successful in trapping particles as small as viruses that can have a dimension about 0.005 to about 0.02 micron, tobacco smoke that can have a particle size that ranges from about 0.01 to about 1 micron, household dust having a particle size that ranges from about 0.5 up to 100 microns, bacteria having particle sizes that can range from about 0.03 to about 20 microns, household dust that can range from about 0.1 to about 100 microns and other harmful or undesirable particulate materials. The effective filtration activity of the media of the invention can be present in particles as small as 0.02 micron up to 100 microns and larger.

The polymer materials as disclosed herein have substantially improved resistance to the undesirable effects of heat, humidity, high flow rates, reverse pulse cleaning, operational abrasion, submicron particulates, cleaning of filters in use and other demanding conditions. The improved microfiber and nanofiber performance is a result of the improved character of the polymeric materials forming the microfiber or nanofiber. Further, the filter media of the invention using the improved polymeric materials of the invention provides a number of advantageous features including higher efficiency, lower flow restriction, high durability (stress related or environmentally related) in the presence of abrasive particulates and a smooth outer surface free of loose fibers or fibrils. The overall structure of the filter materials provides an overall thinner media allowing improved media area per unit volume, reduced velocity through the media, improved media efficiency and reduced flow restrictions. Preparing the media of the invention from fine fiber provides a media layer with substantial depth that is made entirely from fine fiber providing the high quality of fine fiber filtration activity in a media structure that can be easily handled and assembled into filter structures while maintaining small fiber size, small pore size, high permeability and acceptable solidity.

Polymers used in the media include polyolefins such as polyethylene and polypropylene, nylon, PVC, polyesters such as PET, PBT, polyether-sulfone, PVDF, polycarbonate, styrene polymers and copolymers and others.

A preferred mode of the invention is a polymer blend comprising a first polymer and a second, but different polymer (differing in polymer type, molecular weight or physical property) that is conditioned or treated at elevated temperature. The polymer blend can be reacted and formed into a single chemical specie or can be physically combined into a blended composition by an annealing process. Annealing implies a physical change, like crystallinity, stress relaxation or orientation. Preferred materials are chemically reacted into a single polymeric specie such that a Differential Scanning Calorimeter analysis reveals a single polymeric material. Such a material, when combined with a preferred additive material, can form a surface coating of the additive on the microfiber that provides oleophobicity, hydrophobicity or other associated improved stability when contacted with high temperature, high humidity and difficult operating conditions. Such microfibers can have a smooth surface comprising a discrete layer of the additive material or an outer coating of the additive material that is partly solubilized or alloyed in the polymer surface, or both. Preferred materials for use in the blended polymeric systems include nylon 6; nylon 66; nylon 6-10; nylon (6-66-610) copolymers and other linear generally aliphatic nylon compositions. A preferred nylon copolymer resin (SVP-651) was analyzed for molecular weight by the end group titration. (J. E. Walz and G. B. Taylor, determination of the molecular weight of nylon, Anal. Chem. Vol. 19, Number 7, pp 448-450 (1947). A number average molecular weight (Wₙ) was between 21,500 and 24,800. The composition was estimated by the phase diagram of melt temperature of three component nylon, nylon 6 about 45%, nylon 66 about 20% and nylon 610 about 25%. (Page 286, Nylon Plastics Handbook, Melvin Kohan ed. Hanser Publisher, New York (1995)).

A polyvinylalcohol having a hydrolysis degree of from 87 to 99.9+% can be used in such polymer systems. These are preferably cross linked. And they are most preferably crosslinked and combined with substantial quantities of the oleophobic and hydrophobic additive materials.

Another preferred mode of the invention involves a single polymeric material combined with an additive composition to improve fiber lifetime or operational properties.

A particularly preferred material of the invention comprises a fiber material having a dimension of about 0.1 to 1 micron. The most preferred fiber size range between 0.03 to 0.5 micron. Such fibers with the preferred size provide excellent filter activity, ease of back pulse cleaning and other aspects. In such a mode, the polymer material must stay attached to the substrate while undergoing a pulse clean input that is substantially equal to the typical filtration conditions except in a reverse direction across the filter structure. Such adhesion can arise from solvent effects of fiber formation as the fiber is contacted with the substrate or the post treatment of the fiber on the substrate with heat or pressure. However, polymer characteristics appear to play an important role in determining adhesion, such as specific chemical interactions like hydrogen bonding, contact between polymer and substrate occurring above or below Tg, and the polymer formulation including additives. Polymers plasticized with solvent or steam at the time of adhesion can have increased adhesion.

An important aspect of the invention is the utility of such microfiber or nanofiber materials formed into a filter structure. In such a structure, the fine fiber materials of the invention act as the separate media of the filter. Other media can also be used in a filter with the fine fiber medium. Natural fiber and synthetic fiber substrates, like spun bonded fabrics, non-woven fabrics of synthetic fiber and non-wovens made from the blends of cellulosics, synthetic and glass fibers, non-woven and woven glass fabrics, plastic screen like materials both extruded and hole punched, UF and MF membranes of organic polymers can be used. Sheet-like substrate or cellulosic non-woven web can then be formed into a filter structure that is placed in a fluid stream including an air stream or liquid stream for the purpose of removing suspended or entrained particulate from that stream. The shape and structure of the filter structure is up to the design engineer.

Polymer materials that can be used in the polymeric compositions of the invention include both addition polymer and condensation polymer materials such as polyolefin, polyacetal, polyamide, polyester, cellulose ether and ester, polyalkylene sulfide, polyarylene oxide, polysulfone, modified polysulfone polymers and mixtures thereof. Preferred materials that fall within these generic classes include polyethylene, polypropylene, poly(vinylchloride), polymethylmethacrylate (and other acrylic resins), polystyrene, and copolymers thereof (including ABA type block copolymers), poly(vinylidene fluoride), poly(vinylidene chloride), polyvinylalcohol in various degrees of hydrolysis (87% to 99.5%) in crosslinked and non-crosslinked forms. Preferred addition polymers tend to be glassy (a Tg greater than room temperature). This is the case for polyvinylchloride and polymethylmethacrylate, polystyrene polymer compositions or alloys or low in crystallinity for polyvinylidene fluoride and polyvinylalcohol materials. One class of polyamide condensation polymers are nylon materials. The term “nylon” is a generic name for all long chain synthetic polyamides. Typically, nylon nomenclature includes a series of numbers such as in nylon-6,6 which indicates that the starting materials are a C₆ diamine and a C₆ diacid (the first digit indicating a C₆ diamine and the second digit indicating a C₆ dicarboxylic acid compound). Another nylon can be made by the polycondensation of epsilon caprolactam in the presence of a small amount of water. This reaction forms a nylon-6 (made from a cyclic lactam—also known as episilon-aminocaproic acid) that is a linear polyamide. Further, nylon copolymers are also contemplated. Copolymers can be made by combining various diamine compounds, various diacid compounds and various cyclic lactam structures in a reaction mixture and then forming the nylon with randomly positioned monomeric materials in a polyamide structure. For example, a nylon 6,6-6,10 material is a nylon manufactured from hexamethylene diamine and a C₆ and a C ₁₀ blend of diacids. A nylon 6-6,6-6,10 is a nylon manufactured by copolymerization of epsilonaminocaproic acid, hexamethylene diamine and a blend of a C₆ and a C₁₀ diacid material.

Block copolymers are also useful in the process of this invention. With such copolymers the choice of solvent swelling agent is important. The selected solvent is such that both blocks were soluble in the solvent. One example is a ABA (styrene-EP-styrene) or AB (styrene-EP) polymer in methylene chloride solvent. If one component is not soluble in the solvent, it will form a gel. Examples of such block copolymers are Kraton®type of styrene-b-butadiene and styrene-b-hydrogenated butadiene(ethylene propylene), Pebax® type of e-caprolactam-b-ethylene oxide, Sympatex® polyester-b-ethylene oxide and polyurethanes of ethylene oxide and isocyanates.

Addition polymers like polyvinylidene fluoride, syndiotactic polystyrene, copolymer of vinylidene fluoride and hexafluoropropylene, polyvinyl alcohol, polyvinyl acetate, amorphous addition polymers, such as poly(acrylonitrile) and its copolymers with acrylic acid and methacrylates, polystyrene, poly(vinyl chloride) and its various copolymers, poly(methyl methacrylate) and its various copolymers, can be solution spun with relative ease because they are soluble at low pressures and temperatures. However, highly crystalline polymer like polyethylene and polypropylene require high temperature, high pressure solvent if they are to be solution spun. Therefore, solution spinning of the polyethylene and polypropylene is very difficult. Electrostatic solution spinning is one method of making nanofibers and microfiber.

We have also found a substantial advantage to forming polymeric compositions comprising two or more polymeric materials in polymer admixture, alloy format or in a crosslinked chemically bonded structure. We believe such polymer compositions improve physical properties by changing polymer attributes such as improving polymer chain flexibility or chain mobility, increasing overall molecular weight and providing reinforcement through the formation of networks of polymeric materials.

In one embodiment of this concept, two related polymer materials can be blended for beneficial properties. For example, a high molecular weight polyvinylchloride can be blended with a low molecular weight polyvinylchloride. Similarly, a high molecular weight nylon material can be blended with a low molecular weight nylon material. Further, differing species of a general polymeric genus can be blended. For example, a high molecular weight styrene material can be blended with a low molecular weight, high impact polystyrene. A Nylon-6 material can be blended with a nylon copolymer such as a Nylon-6; 6,6; 6,10 copolymer. Further, a polyvinylalcohol having a low degree of hydrolysis such as a 87% hydrolyzed polyvinylalcohol can be blended with a fully or superhydrolyzed polyvinylalcohol having a degree of hydrolysis between 98 and 99.9% and higher. All of these materials in admixture can be crosslinked using appropriate crosslinking mechanisms. Nylons can be crosslinked using crosslinking agents that are reactive with the nitrogen atom in the amide linkage. Polyvinylalcohol materials can be crosslinked using hydroxyl reactive materials such as monoaldehydes, such as formaldehyde, ureas, melamine-formaldehyde resin and its analogues, boric acids and other inorganic compounds. dialdehydes, diacids, urethanes, epoxies and other known crosslinking agents. Crosslinking technology is a well known and understood phenomenon in which a crosslinking reagent reacts and forms covalent bonds between polymer chains to substantially improve molecular weight, chemical resistance, overall strength and resistance to mechanical degradation.

We have found that additive materials can significantly improve the properties of the polymer materials in the form of a fine fiber. The resistance to the effects of heat, humidity, impact, mechanical stress and other negative environmental effect can be substantially improved by the presence of additive materials. We have found that while processing the microfiber materials of the invention, that the additive materials can improve the oleophobic character, the hydrophobic character and can appear to aid in improving the chemical stability of the materials. We believe that the fine fibers of the invention in the form of a microfiber are improved by the presence of these oleophobic and hydrophobic additives as these additives form a protective layer coating, ablative surface or penetrate the surface to some depth to improve the nature of the polymeric material. We believe the important characteristics of these materials are the presence of a strongly hydrophobic group that can preferably also have oleophobic character. Strongly hydrophobic groups include fluorocarbon groups, hydrophobic hydrocarbon surfactants or blocks and substantially hydrocarbon oligomeric compositions. These materials are manufactured in compositions that have a portion of the molecule that tends to be compatible with the polymer material affording typically a physical bond or association with the polymer while the strongly hydrophobic or oleophobic group, as a result of the association of the additive with the polymer, forms a protective surface layer that resides on the surface or becomes alloyed with or mixed with the polymer surface layers. For 0.2-micron fiber with 10% additive level, the surface thickness is calculated to be around 50 Å, if the additive has migrated toward the surface. Migration is believed to occur due to the incompatible nature of the oleophobic or hydrophobic groups in the bulk material. A 50 Å thickness appears to be reasonable thickness for protective coating. For 0.05-micron diameter fiber, 50 Å thickness corresponds to 20% mass. For 2 microns thickness fiber, 50 A thickness corresponds to 2% mass. Preferably the additive materials are used at an amount of about 2 to 25 wt. %. Oligomeric additives that can be used in combination with the polymer materials of the invention include oligomers having a molecular weight of about 500 to about 5000, preferably about 500 to about 3000 including fluoro-chemicals, nonionic surfactants and low molecular weight resins or oligomers. Fluoro-organic wetting agents can also be useful in this invention

Further, nonionic hydrocarbon surfactants including lower alcohol ethoxylates, fatty acid ethoxylates, nonylphenol ethoxylates, etc. can also be used as additive materials for the invention. Examples of these materials include Triton X-100 and Triton N-101.

A useful material for use as an additive material in the compositions of the invention are tertiary butylphenol oligomers. Such materials tend to be relatively low molecular weight aromatic phenolic resins. Such resins are phenolic polymers prepared by enzymatic oxidative coupling direct from aromatic ring to aromatic ring. The absence of methylene bridges result in unique chemical and physical stability. Examples of these phenolic materials include Enzo-BPA, Enzo-BPA/phenol, Enzo-TBP, Enzo-COP and other related phenolics were obtained from Enzymol International Inc., Columbus, Ohio.

With respect to media geometry, preferred geometries are typically pleated, cylindrical, patterns. Such cylindrical patterns are generally preferred because they are relatively straightforward to manufacture, use conventional filter manufacturing techniques, and are relatively easy to service. The pleating of media increases the surface area positioned within a given volume. Generally, major parameters with respect to such media positioning are: pleat depth; pleat density, typically measured as a number of pleats per inch along the inner diameter of the pleated media cylinder; and, cylindrical length or pleat length. In general, a principal factor with respect to selecting media pleat depth, pleat length, and pleat density, especially for barrier (non-hybrid) arrangements is the total surface area required for any given application or situation. Such principles would apply, generally, to media of the invention and preferably to similar barrier type arrangements.

Depth media systems, or systems using a combination of barrier media and depth media, as indicated in U.S. Pat. No. 5,423,892, are less restricted with respect to geometry than are strictly barrier systems. For example, attention is directed to U.S. Pat. No. 5,423,892 at column 18, line 60-column 21, line 68. However, in general, to date such arrangements, especially with respect to vehicle filters, have been made in about the same size and shape (typically having at least about 66% of the same media volume and generally more) as pleated media arrangements for similar applications. Thus, in those instances in which the entire media construction is positioned between inner and outer liners, the media volume is generally the cylindrical volume defined between the inner and outer liners, and can be calculated in the same manner as indicated above.

With respect to efficiency, principles vary with respect to the type of media involved. For example, cellulose fiber or similar barrier media is generally varied, with respect to efficiency, by varying overall general porosity or permeability. Also, as explained in U.S. Pat. No. 5,423,892 and 5,672,399, the efficiency of barrier media can be modified in some instances by oiling the media and in others by applying, to a surface of the media, a deposit of relatively fine fibers, typically less than 5 microns and in many instances submicron sized (average) fibers. With respect to fibrous depth media constructions, for example, dry laid fibrous media, as explained in U.S. Pat. No. 5,423,892, variables concerning efficiency include: percent solidity of the media, and how compressed the media is within the construction involved; overall thickness or depth; and, fiber size.

A filter media construction according to the present invention includes a layer of fine fiber media is secured to filter structure.

The first layer of permeable fine fiber material comprises a material which, if evaluated separately from a remainder of the construction by the Frazier permeability test, would exhibit a permeability of at least 3.5 m-min⁻¹, and typically and preferably about 20 m-min⁻¹. Herein when reference is made to efficiency, unless otherwise specified, reference is meant to efficiency when measured according to ASTM-1215-89, with 0.78 μ monodisperse polystyrene spherical particles, at 20 fl-m⁻¹ (6.1 m-min⁻¹) as described herein.

The foregoing general description of the various aspects of the polymeric materials of the invention, the fine fiber materials of the invention and the construction of useful filter structures from the fine fiber materials of the invention provides an understanding of the general technological principles of the operation of the invention. Electrospinning small diameter fiber less than 10 micron is obtained using an electrostatic force from a strong electric field acting as a pulling force to stretch a polymer jet into a very fine filament. A polymer melt can be used in the electrospinning process, however, fibers smaller than 1 micron are best made from polymer solution. As the polymer mass is drawn down to smaller diameter, solvent evaporates and contributes to the reduction of fiber size. Choice of solvent is critical for several reasons. If solvent dries too quickly, then fibers tends to be flat and large in diameter. If the solvent dries too slowly, solvent will redissolve the formed fibers. Therefore matching drying rate and fiber formation is critical. At high production rates, large quantities of exhaust air flow helps to prevent a flammable atmosphere, and to reduce the risk of fire. A solvent that is not combustible is helpful. In a production environment the processing equipment will require occasional cleaning. Safe low toxicity solvents minimize worker exposure to hazardous chemicals.

The microfiber or nanofiber of the unit can be formed by the electrostatic spinning process. An electro spinning apparatus includes a reservoir in which the fine fiber forming polymer solution is contained, a pump and an emitting device to which the polymeric solution is pumped. The emitter obtains polymer solution from the reservoir and in the electrostatic field, a droplet of the solution is accelerated by the electrostatic field toward the collecting media as discussed below. Facing the emitter, but spaced apart therefrom, is a substantially planar grid upon which the collecting media substrate or combined substrate is positioned. Air can be drawn through the grid.

The collecting media is positioned proximate the grid. A high voltage electrostatic potential is maintained between emitter and grid with the collection substrate positioned there between by means of a suitable electrostatic voltage source and connections and that connect respectively to the grid and emitter.

In use, the polymer solution is pumped to the emitter. The electrostatic potential between grid and the emitter imparts a charge to the material that cause liquid to be emitted there from as thin fibers which are drawn toward grid where they arrive and are collected on substrate in sufficient quantity to form a robust, mechanically stable unitary layer or layers. The filter media of the invention is formed into an initial layer or layers that is about 0.1 to 300, preferably 1 to 200 microns in thickness. In the case of the polymer in solution, solvent is evaporated off the fibers during their flight to the grid; therefore, the fibers arrive at the collection substrate. The fine fibers bond to the substrate fibers first encountered at the grid. Electrostatic field strength is selected to ensure that the polymer material as it is accelerated from the emitter to the collecting substrate media, the acceleration is sufficient to render the material into a very thin microfiber or nanofiber structure. Increasing or slowing the advance rate of the collecting media can deposit more or less emitted fibers on the forming media, thereby allowing control of the thickness of each layer deposited thereon. The sheet-like collection substrate is formed with fine fiber. The sheet-like substrate is then directed to a separation station wherein the fine fiber layer or layers is removed from the substrate, if needed, in a continuous operation. If further layers are to be formed the continuous length of sheet-like substrate is directed to a fine fiber spinning station wherein the spinning device forms additional fine fiber layers and lays the fine fiber in a filtering layer. After the fine fiber layer(s) are formed on the sheet-like substrate, the fine fiber layer and substrate are directed to a heat treatment and pressure such as a calendaring station for appropriate processing to form the layer(s) into a final layer with a compressed thickness and basis weight. The sheet-like substrate and fine fiber layer is then tested for QC in an appropriate station such as an efficiency monitor. The sheet-like substrate and fiber layer is then steered to the appropriate filter manufacturing station or to a winding station to be wound onto the appropriate spindle for further processing or later filter manufacture.

After processing, the media of the invention, the media can comprise a single layer or multilayers of the fine fiber formed into a continuous sheet-like media structure. After processing is complete and the media is in its final thickness, a single layer of the media structure can comprise a final depth of about 0.1 to about 100 microns, preferably about 1 to about 50 microns, most preferably about 1 to about 15 microns. In multilayer structures, the overall final thickness can range from about 0.1 to about 100 microns with each individual layer having a thickness of about 0.1 to about 100 microns, preferably about 0.3 to about 50 microns. The overall solidity, average pore size, permeability, and basis weight are as follows:

TABLE
PARAMETERS¹

| Fiber | | | | Flux at 10 psi |
|---|---|---|---|---|
| Diameter | Solidity | Thickness | Basis Weight | Water |
| (Microns) | (Vol %) | (Microns) | (ug/cm²) | (mL/min/cm²) |
| 0.03 | 5 | 1 | 5.25 | 1400 |
| 0.03 | 30 | 1 | 31.5 | 19 |
| 0.03 | 5 | 100 | 525 | 9 |
| 0.03 | 30 | 100 | 3150 | 0.2 |
| 0.157 | 20 | 25 | 525 | 62 |
| 0.5 | 5 | 1 | 5.25 | 750000 |
| 0.5 | 30 | 1 | 31.5 | 17000 |
| 0.5 | 5 | 100 | 525 | 2400 |
| 0.5 | 30 | 100 | 3150 | 55 |

¹Fiber density 1.14 g/cm³
Normal Fibers
Sigma g calculate

Certain preferred arrangements according to the present invention include filter media as generally defined, in an overall filter construction. Some preferred arrangements for such use comprise the media arranged in a cylindrical, pleated configuration with the pleats extending generally longitudinally, i.e. in the same direction as a longitudinal axis of the cylindrical pattern. For such arrangements, the media may be imbedded in end caps, as with conventional filters. Such arrangements may include upstream liners and downstream liners if desired, for typical conventional purposes.

In some applications, media according to the present invention may be used in conjunction with other types of media, for example conventional media, to improve overall filtering performance or lifetime. For example, media according to the present invention may be laminated to conventional media, be utilized in stack arrangements; or be incorporated (an integral feature) into media structures including one or more regions of conventional media. It may be used upstream of such media, for good load; and/or, it may be used downstream from conventional media, as a high efficiency polishing filter.

Certain arrangements according to the present invention may also be utilized in liquid filter systems, i.e. wherein the particulate material to be filtered is carried in a liquid. Also, certain arrangements according to the present invention may be used in mist collectors, for example arrangements for filtering fine mists from air.

According to the present invention, methods are provided for filtering. The methods generally involve utilization of media as described to advantage, for filtering. As will be seen from the descriptions and examples below, media according to the present invention can be specifically configured and constructed to provide relatively long life in relatively efficient systems, to advantage.

Various filter designs are shown in patents disclosing and claiming various aspects of filter structure and structures used with the filter materials. Engel et al., U.S. Pat. No. 4,720,292, disclose a radial seal design for a filter assembly having a generally cylindrical filter element design, the filter element being sealed by a relatively soft, rubber-like end cap having a cylindrical, radially inwardly facing surface. Kahlbaugh et al., U.S. Pat. No. 5,082,476, disclose a filter design using a depth media comprising a foam substrate with pleated components combined with the microfiber materials of the invention. Stifelman et al., U.S. Pat. No. 5,104,537, relate to a filter structure useful for filtering liquid media. Liquid is entrained into the filter housing, passes through the exterior of the filter into an interior annular core and then returns to active use in the structure. Such filters are highly useful for filtering hydraulic fluids. Engel et al., U.S. Pat. No. 5,613,992, show a typical diesel engine air intake filter structure. The structure obtains air from the external aspect of the housing that may or may not contain entrained moisture. The air passes through the filter while the moisture can pass to the bottom of the housing and can drain from the housing. Gillingham et al., U.S. Pat. No. 5,820,646, disclose a Z filter structure that uses a specific pleated filter design involving plugged passages that require a fluid stream to pass through at least one layer of filter media in a “Z” shaped path to obtain proper filtering performance. The filter media formed into the pleated Z shaped format can contain the fine fiber media of the invention. Glen et al., U.S. Pat. No. 5,853,442, disclose a bag house structure having filter elements that can contain the fine fiber structures of the invention. Berkhoel et al., U.S. Pat. No. 5,954,849, show a dust collector structure useful in processing typically air having large dust loads to filter dust from an air stream after processing a workpiece generates a significant dust load in an environmental air. Lastly, Gillingham, U.S. Design Pat. No. 425,189, discloses a panel filter using the Z filter design.

The foregoing description of the different aspects of the invention provide a basis for understanding the structure of the fine fiber media in a filter structure of the invention. The following examples and data further illustrate the functional properties of the invention. The exemplified materials are specific embodiments of the invention and are not intended to narrow the scope of the claims.

As a basis of comparison, a line of Millipore cellulose acetate and nitrate membranes were characterized in terms of a variety of operating parameters shown in the Table I below. These results showed both liquid and gas performance.

TABLE 1
FIBER DIAMETER OF COMMERCIAL MEDIA -
BASED ON LIQUID CAPILLARY TUBE MODEL

| | | | | | Effective | Mean |
|---|---|---|---|---|---|---|
| | | | Thick- | Liquid | Fiber | Pore |
| Manu- | | Soli- | ness | Flow | Diameter | Size |
| facturer | Grade | dity | (μm) | (ml/m/cm²) | (μm) | (μm) |
| Commercial | A | 0.16 | 150 | 630 | 0.8892 | 2.952 |
| Competitor | B | 0.16 | 150 | 400 | 0.7085 | 2.353 |
| (Cellulose | C | 0.17 | 150 | 296 | 0.6593 | 2.036 |
| Acetate & | D | 0.18 | 150 | 222 | 0.6157 | 1.774 |
| Nitrate) | E | 0.18 | 150 | 157 | 0.5177 | 1.492 |
| Filter | F | 0.19 | 150 | 111 | 0.4681 | 1.262 |
| | G | 0.21 | 150 | 38.5 | 0.3163 | 0.753 |
| | H | 0.23 | 150 | 29.6 | 0.3157 | 0.668 |
| | I | 0.25 | 150 | 15.6 | 0.2591 | 0.492 |
| | J | 0.26 | 150 | 1.5 | 0.0853 | 0.153 |
| | K | 0.28 | 150 | 0.74 | 0.0672 | 0.109 |
| | L | 0.3 | 150 | 0.15 | 0.0338 | 0.050 |

Based on these data we believe improved filter media can be made by reducing pore size reducing fiber diameter but maintaining solidity, permeability and resistance increased pressure drop. If the pore size distribution can be narrowed, a thinner structure that has equal separation characteristics as the conventional Millipore membrane candidate can be made with a substantial increase in flow rate.

Table 2 and 3 lists the results of the solidity increase and inter fiber space obtained by reducing the thickness of the layers at constant mass. Comparing table 1 with tables 2 and 3 reveals that reducing the thickness of the layer to 80 micron will give a mitered cylinder inter-fiber space comparable to a Millipore 0.22 membrane. Further calendaring to a thickness of about 20 microns would bring a mitered cylinder inter-fiber space close to the suggested manufacturer's pore rating. Similarly, at a solidity of the 0.25, comparable to Millipore 0.22 membrane, a filtration structure with an average inter fiber space at 0.5 micron and a mean pore size of 0.19 micron would have been increased flow rate by roughly a factor of 4 through the substantial thickness reduction from 150 to 40 microns. Further, if two 40 microns layers are joined, a flow advantage of a factor of about 2, with enhanced separation efficiency can be achieved. Based on these models, we believe a large flow rate advantage at similar or improved efficiencies can be achieved with a calendared fine fiber matrix in either a single or multilayer structure. Tables 2 and 3 sets forth a calculation of filter characteristics of the improved media.

TABLE 2
FILTER CHARACTERISTICS OF COMMERCIAL MEDIA -
BASED ON LIQUID CAPILLARY TUBE MODEL

| | | | | | Pore | | |
|---|---|---|---|---|---|---|---|
| | Solidity | | | | Diameter | | |
| | C | Thickness | I.F. Space | I.F. Space | Dp | # Layers | # Layers |
| | (%) | (μm) | Im (μm) | Ic (μm) | (μm) | Mm (#) | Mc (#) |
| Fiber Diameter 0.889 (μm) | 0.160 | 150.0 | 7.443 | 1.334 | 2.952 | 168.7 | 67.5 |
| Initial Thickness 150 (μm) | | | | | | | |
| Millipore SC 8 | | | | | | | |
| Fiber Diameter 0.709 (μm) | 0.160 | 150.0 | 5.936 | 1.064 | 2.354 | 211.6 | 84.6 |
| Initial Thickness 150 (μm) | | | | | | | |
| Millipore SM 5 | | | | | | | |
| Fiber Diameter 0.659 (μm) | 0.170 | 150.0 | 5.136 | 0.939 | 2.035 | 227.6 | 93.8 |
| Initial Thickness 150 (μm) | | | | | | | |
| Millipore SS 3 | | | | | | | |
| Fiber Diameter 0616 (μm) | 0.180 | 150.0 | 4.484 | 0.836 | 1.775 | 243.5 | 103.3 |
| Initial Thickness 150 (μm) | | | | | | | |
| Millipore RA 1.2 | | | | | | | |
| Fiber Diameter 0.518 (μm) | 0.180 | 150.0 | 3.770 | 0.703 | 1.492 | 289.6 | 122.9 |
| Initial Thickness 150 (μm) | | | | | | | |
| Millipore AA .80 | | | | | | | |
| Fiber Diameter 0.468 (μm) | 0.190 | 150.0 | 3.191 | 0.606 | 1.262 | 320.5 | 139.7 |
| Initial Thickness 150 (μm) | | | | | | | |
| Millipore DA .65 | | | | | | | |
| Fiber Diameter 0.316 (μm) | 0.210 | 150.0 | 1.905 | 0.374 | 0.752 | 474.7 | 217.5 |
| Initial Thickness 150 (μm) | | | | | | | |
| Millipore HA .45 | | | | | | | |
| Fiber Diameter 0.316 (μm) | 0.230 | 150.0 | 1.698 | 0.343 | 0.669 | 474.7 | 227.7 |
| Initial Thickness 150 (μm) | | | | | | | |
| Millipore PH .30 | | | | | | | |
| Fiber Diameter 0.259 (μm) | 0.250 | 150.0 | 1.250 | 0.259 | 0.491 | 579.2 | 289.6 |
| Initial Thickness 150 (μm) | | | | | | | |
| Millipore GS .20 | | | | | | | |
| Fiber Diameter 0.0853 (μm) | 0.260 | 150.0 | 0.391 | 0.082 | 0.154 | 1758.5 | 896.7 |
| Initial Thickness 150 (μm) | | | | | | | |
| Millipore VC .10 | | | | | | | |
| Skinned | | | | | | | |
| Fiber Diameter 0.0672 (μm) | 0.280 | 150.0 | 0.279 | 0.060 | 0.109 | 2232.1 | 1181.1 |
| Initial Thickness 150 (μm) | | | | | | | |
| Millipore VM .05 | | | | | | | |
| Skinned | | | | | | | |
| Fiber Diameter 0.0338 | 0.300 | 150.0 | 0.127 | 0.028 | 0.050 | 4437.9 | 2430.7 |
| Initial Thickness 150 (μm) | | | | | | | |
| Millipore VS .025 | | | | | | | |
| Skinned | | | | | | | |

TABLE 3
DATA OF THE INVENTION
THE SOLIDITY INCREASE AND
INTER-FIBER DECREASE FROM THICKNESS REDUCTION AT CONSTANT MASS

| | | | Inter Fiber. | Inter Fiber | Pore | # Layers | # Layers |
|---|---|---|---|---|---|---|---|
| Fiber Diameter 0.1 (μm) | Solidity | | Space M.C. | Space C. | Diameter | M.C. Model | C. Model |
| Initial Thickness 240 (μm) | C | Thickness T | Model Im | Model | Dp | Mm | Mc |
| CMM 4% | (%) | (μm) | (μm) | Ic (μm) | (μm) | (#) | (#) |
| | 0.040 | 240.0 | 3.783 | 0.400 | 1.518 | 2400.0 | 480.0 |
| | 0.08 | 120.0 | 1.820 | 0.254 | 0.727 | 1200.0 | 339.4 |
| | 0.09 | 106.7 | 1.602 | 0.233 | 0.639 | 1066.7 | 320.0 |
| | 0.1 | 96.0 | 1.427 | 0.216 | 0.569 | 960.0 | 303.6 |
| | 0.12 | 80.0 | 1.165 | 0.189 | 0.464 | 800.0 | 277.1 |
| | 0.14 | 68.6 | 0.978 | 0.167 | 0.389 | 685.7 | 256.6 |
| | 0.16 | 60.0 | 0.837 | 0.150 | 0.332 | 600.0 | 240.0 |
| | 0.18 | 53.3 | 0.728 | 0.136 | 0.288 | 533.3 | 226.3 |
| | 0.2 | 48.0 | 0.640 | 0.124 | 0.253 | 480.0 | 214.7 |
| | 0.23 | 41.7 | 0.537 | 0.109 | 0.212 | 417.4 | 200.2 |
| | 0.25 | 38.4 | 0.483 | 0.100 | 0.190 | 384.0 | 192.0 |
| | 0.3 | 32.0 | 0.377 | 0.083 | 0.148 | 320.0 | 175.3 |
| | 0.35 | 27.4 | 0.301 | 0.069 | 0.117 | 274.3 | 162.3 |
| | 0.4 | 24.0 | 0.244 | 0.058 | 0.095 | 240.0 | 151.8 |
| | 0.45 | 21.3 | 0.200 | 0.049 | 0.077 | 213.3 | 143.1 |
| | 0.5 | 19.2 | 0.164 | 0.041 | 0.063 | 192.0 | 135.8 |
| | 0.55 | 17.5 | 0.134 | 0.035 | 0.052 | 174.5 | 129.4 |

The above specification, examples and data provide a complete description of the manufacture and use of the composition of the invention. Since many embodiments of the invention can be made without departing from the spirit and scope of the invention, the invention resides in the claims hereinafter appended.

We claim:

1. A polymeric filter media substantially free of a perflourinated polymeric material, the media comprising a collection of fiber, comprising an organic polymer, the fiber having a diameter of about 0.03 to 0.5 microns, the filter media comprising a layer having a thickness of about 1 to 100 microns and the media having a solidity of about 5% to 50%.

2. The polymeric filter media of claim 1, wherein the solidity is about 5% to 30%.

3. The media of claim 1 wherein the media has a thickness of about 5 to 100 microns and a flux of greater than 10 mL-min⁻¹-cm² of water at 10 psi.

4. The media claim 1 comprising two or more fiber layers, each fiber layer independently having a thickness of less than about 20 microns and wherein the media has a flux of greater than 10 mL-min⁻¹-cm² of water at 10 psi and a filtration efficiency of at least about 98% with a particle about 0.2 microns at a flow rate of approximately 20 mL/min/cm² of water.

5. The media claim 1 wherein the fiber body thickness is about 5 to 80 microns and wherein the media has a flux of greater than 10 mL-min⁻¹-cm² of water at 10 psi and a filtration efficiency of at least about 98% on a particle about 0.2 microns at a flow rate of approximately 20 mL/min/cm².

6. The media of claim 1 wherein the media solidity is about 7% to 25% and wherein the media has a flux of greater than 10 mL-min⁻¹-cm² of water at 10 psi and a filtration efficiency of at least about 98% on a particle about 0.2 microns at a flow rate of approximately 20 mL/min/cm² of water.

7. The media of claim 1 wherein the filter media is a wound media or a pleated media and is combined with a porous support.

8. The media of claim 6 wherein the media comprises a layer of media in a flat-panel filter or a cylindrical filter.

9. The media of claim 1 wherein the fiber diameter comprises about 0.05 to 0.4 microns.

10. The media of claim 1 wherein the fiber comprises a nylon fiber.

11. The media of claim 1 wherein the fiber comprises a polyolefin.

12. The media of claim 10 wherein the polyolefin comprises a polyethylene or a polypropylene.

13. The media of claim 1 wherein the fiber comprises a polyvinyl chloride.

14. The media of claim 1 wherein the fiber comprises a polyacrylonitrile fiber.

15. The media of claim 1 wherein the fiber comprises a polyether sulfone.

16. The media of claim 1 wherein the fiber comprises polyester.

17. The media of claim 15 wherein the polyester comprises a PET or a PBT.

18. The media of claim 1 wherein the fiber comprises a polyvinylidene fluoride.

19. The media of claim 10 wherein the fiber comprises a nylon fiber comprising a phenolic additive.

20. The media of claim 10 wherein the fiber comprises a polycarbonate.

21. The media of claim 10 wherein the fiber comprises a styrene polymer.

22. A polymeric filter media substantially free of a perfluorinated polymer material, the media comprising at least two layers of organic polymeric fiber, the fiber having a diameter of about 0.03 to 0.5 microns, the layers bonded into a unitary body, the body having a thickness of at about 2 to 100 microns and the body having a solidity of about 5% to 50%.

23. The polymeric filter media of claim 22, wherein the solidity is about 5% to 30%.

24. The media of claim 22 wherein the media has a flux of greater than 10 mL-min⁻¹-cm² of water at 10 psi.

25. The media of claim 22 comprising two or more layers, each layer independently having a thickness of less than about 20 microns and wherein the media has a flux of about 15 to 60 mL-min⁻¹-cm² of water at 10 psi and a filtration efficiency of at least about 98% with a particle about 0.2 microns at a flow rate of approximately 20 mL/min/cm² of water.

26. The media of claim 22 wherein the fiber body thickness is about 5 to 80 microns and each layer thickness is independently about 5 to 25 microns and wherein the media has a flux of about 15 to 60 mL-min⁻¹-cm² of water at 10 psi and a filtration efficiency of at least about 98% with a particle about 0.2 microns at a flow rate of approximately 20 mL/min/cm² of water.

27. The media of claim 22 wherein the solidity of the fiber body is about 7% to 25% and wherein the media has a flux of greater than 10 mL-min⁻¹-cm² of water at 10 psi and a filtration efficiency of at least about 98% on with a particle about 0.2 microns at. a flow rate of approximately 20 mL/min/cm² of water.

28. The media of claim 22 wherein the filter media is combined with a porous support.

29. The media of claim 28 wherein the media comprises a flat-panel media

30. The media of claim 28 wherein the media comprises a cylindrical media.

31. The media of claim 23 wherein the fiber diameter comprises about 0.05 to 0.4 microns.

32. The media of claim 23 wherein the fiber comprises a nylon fiber.

33. The media of claim 23 wherein the fiber comprises a polyacrylonitrile fiber.

34. The media of claim 23 wherein the fiber comprises a nylon fiber comprising a phenolic additive.

35. The media of claim 23 wherein filter structure comprises 3 to 5 layers of fiber, the body having a thickness about 5 to 50 microns and each layer having a thickness less than about 20 microns.

36. The media of claim 23 wherein the media has a flux of greater than 10 mL-min⁻¹-cm² of water at 10 psi.

37. The media of claim 23 comprising two or more layers, each layer independently having a thickness of less than about 20 microns and wherein the media has a flux of about 15 to 60 mL-min⁻¹-cm² of water at 10 psi and a filtration efficiency of at least about 98% with a particle about 0.2 microns at a flow rate of approximately 20 mL/min/cm² of water.

38. The media of claim 23 wherein the fiber body thickness is about 5 to 80 microns and each layer thickness is independently about 5 to 25 microns and wherein the media has a flux of about 15 to 60 mL-min⁻¹-cm² of water at 10 psi and a filtration efficiency of at least about 98% with a particle about 0.2 microns at a flow rate of approximately 20 mL/min/cm² of water.

39. The media of claim 23 wherein the solidity of the fiber body is about 7% to 25% and wherein the media has a flux of greater than 10 mL-min⁻¹-cm² of water at 10 psi and a filtration efficiency of at least about 98% on with a particle about 0.2 microns at. a flow rate of approximately 20 mL/min/cm² of water.

40. The media of claim 23 wherein the filter media is combined with a porous support.

41. The media of claim 40 wherein the media comprises a flat-panel media

42. The media of claim 40 wherein the media comprises a cylindrical media.

43. The media of claim 23 wherein the fiber diameter comprises about 0.05 to 0.4 microns.

44. The media of claim 23 wherein the fiber comprises a nylon fiber.

45. The media of claim 23 wherein the fiber comprises a polyacrylonitrile fiber.

46. The media of claim 45 wherein the fiber comprises a nylon fiber comprising a phenolic additive.

47. The media of claim 23 wherein a polymeric fiber layer comprises a polymer different than an adjacent polymeric fiber layer.

48. The media of claim 23 wherein a fiber layer comprises a thickness different than an adjacent fiber layer.

49. The media of claim 23 wherein the solidity of a fiber layer is different than the solidity of an adjacent fiber layer.

50. The media of claim 23 wherein the fiber diameter comprises about 0.05 to 0.4 microns

51. A filter media substantially free of a perfluorinated polymer material and substantially free of a defect pathway, the media comprising at least two layers of polymeric fiber, the fiber having a diameter of about 0.03 to 0.5 microns, the layers bonded into a unitary body, the body having a thickness of at about 5 to 100 microns and the body having a solidity of about 5% to 50%;
wherein, during filtration of a liquid, the filtration across the media can be maintained at a flux of at least about 10 mL-min⁻¹-cm² of water at 10 psi and a filtration efficiency of greater than 98.5% on a particle about 0.2 microns at a flow rate of approximately 20 mL/min/cm² of water at approximately room temperature for at least 24 hours of filtering operation.

52. The polymeric filter media of claim 51, wherein the solidity is about 5% to 30%.

53. The media of claim 51 wherein the fiber diameter comprises about 0.05 to 0.4 microns.

54. The media of claim 51 comprising two or more layers, each layer independently having a thickness of less than about 20 microns and wherein the media has a flux of about 15 to 60 mL-min⁻¹-cm² of water at 10 psi and a filtration efficiency of at least about 99% with a particle about 0.2 microns at. flow rate of approximately 20 mL/min/cm² of water at approximately room temperature.

55. The media of claim 51 wherein the fiber body thickness is about 5 to 80 microns and each layer thickness is independently about 5 to 25 microns and wherein the media has a flux of about 15 to 60 mL-min⁻¹-cm² of water at 10 psi and a filtration efficiency of at least about 99% on a particle about 0.2 microns at. flow rate of approximately 20 mL/min/cm² of water at approximately room temperature.

56. The media of claim 51 wherein the solidity of the fiber body is about 7% to 25% and wherein the media has a flux of about 15 to 60 mL-min⁻¹-cm² of water at 10 psi and a filtration efficiency of at least about 99% on a particle about 0.2 microns at flow rate of approximately 20 mL/min/cm² of water.

57. The media of claim 51 wherein the media is combined with a porous support.

58. The media of claim 57 wherein the media comprises a flat-panel media.

59. The media of claim 57 wherein the media comprises a cylindrical media.

60. The media of claim 51 wherein the fiber diameter comprises about 0.05 to 0.4 microns.

61. The media of claim 51 wherein the fiber comprises a nylon fiber.

62. The media of claim 1 wherein the fiber comprises a polyacrylonitrile fiber.

63. The media of claim 61 wherein the fiber comprises a nylon fiber comprising a phenolic additive.

64. The media of claim 51 wherein filter structure comprises 3 to 5 layers of fiber, the body having a thickness about 5 to 100 microns and each layer having a thickness less than about 20 microns.

65. The media of claim 51 wherein the media has a flux of greater than 10 mL-min⁻¹-cm² of water at 10 psi.

66. The media of claim 51 comprising two or more layers, each layer independently having a thickness of less than about 20 microns and wherein the media has a flux of about 15 to 60 mL-min⁻¹-cm² of water at 10 psi and a filtration efficiency of at least about 98% with a particle about 0.2 microns at a flow rate of approximately 20 mL/min/cm² of water.

67. The media of claim 51 wherein the fiber body thickness is about 5 to 80 microns and each layer thickness is independently about 5 to 25 microns and wherein the media has a flux of about 15 to 60 mL-min⁻¹-cm of water at 10 psi and a filtration efficiency of at least about 98% with a particle about 0.2 microns at a flow rate of approximately 20 mL/min/cm² of water.

68. The media of claim 51 wherein the solidity of the fiber body is about 7% to 25% and wherein the media has a flux of greater than 10 mL-min⁻¹-cm² of water at 10 psi and a filtration efficiency of at least about 98% on with a particle about 0.2 microns at. a flow rate of approximately 20 mL/min/cm² of water.

69. The media of claim 51 wherein the filter media is combined with a porous support.

70. The media of claim 69 wherein the media comprises a flat-panel media

71. The media of claim 69 wherein the media comprises a cylindrical media.

72. The media of claim 51 wherein the fiber comprises a nylon fiber.

73. The media of claim 51 wherein the fiber comprises a polyacrylonitrile fiber.

74. The media of claim 73 wherein the fiber comprises a nylon fiber comprising a phenolic additive.

75. The media of claim 51 wherein a polymeric fiber layer comprises a polymer different than an adjacent polymeric fiber layer.

76. The media of claim 51 wherein a fiber layer comprises a thickness different than an adjacent fiber layer.

77. The media of claim 51 wherein a fiber layer comprises a fiber size different than an adjacent fiber layer.

78. The media claim 51 wherein the pore size of a fiber layer is different than the pore size of an adjacent fiber layer.

79. The media of claim 51 wherein the solidity of a fiber layer is different than the solidity of an adjacent fiber layer.

80. A method of forming a filter media, the method comprising the steps of:
(a) forming a layer having a thickness of about 1 to 100 microns on a substrate, the fiber having a diameter of about 0.03 to 0.5 micron, the fiber formed by exposing the substrate and a solution of polymer to an electric potential difference greater than 10 kilovolts;
(b) separating the fiber from the substrate to form a layer; and
(c) forming a filter body by combining two or more layers of such fiber.

81. The method of claim 80 wherein the filter body is exposed to a pressure of at least about 5 psi, at a temperature of at least about 100° C., to form a filter media having a thickness of about 5 to 100 microns and a solidity of about 5% to 50%.

82. The polymeric filter media of claim 81, wherein the solidity is about 5% to 30%.

83. The method of claim 80 wherein the body of fiber is formed by combining two or more layers of fiber to form the body and exposing the body to a calendar roll a pressure of about 15 to 100 psi, at a temperature of about 100 to 250° C., to form a filter media solidity of about 7% to 25%.
